(19) United States
(12) Patent Application Publication
(10) Pub. No.: US 2017/0052521 A1
(43) Pub. Date: Feb. 23, 2017

(54) PROGRAMMABLE CONTROLLER AND ARITHMETIC PROCESSING SYSTEM

(71) Applicant: Kabushiki Kaisha Toshiba, Tokyo (JP)

(72) Inventor: Eigo FUKAI, Nakano Tokyo (JP)

(21) Appl. No.: 15/116,648

(22) PCT Filed: Apr. 21, 2015
(86) PCT No.: PCT/JP2015/062091

§ 371 Date: Aug. 4, 2016

(30) Foreign Application Priority Data
May 12, 2014 (JP) 2014-098946

(51) Int. Cl. G05B 19/042

(52) U.S. Cl. CPC G05B 19/0423; G05B 2219/2225

(57) ABSTRACT

A programmable controller according to one embodiment is included in a system including programmable controllers each having a storage and has an arithmetic processor and a transmitter. The arithmetic processor performs arithmetic processing for processing performed in the system. The transmitter controls transmission of log data to one of the programmable controllers of the system to store the log data in the storage of the one programmable controller having a lower arithmetic load on the arithmetic processor than that of the own programmable controller. The log data is associated with the arithmetic processing by the arithmetic processor.

### FIELD

Embodiments of the present invention relate to a programmable controller and an arithmetic processing system.

### BACKGROUND

Programmable controllers are used for controlling various types of machines such as automatic machines in factories or public facilities and familiar machines. Programmable controllers have a mechanism for obtaining information from a sensor or the like of a machine as input information and calculating a command value and outputting it to an actuator of the machine.

The programmable controllers are installed in a wide variety of systems and places. Data corruption or anomaly in the processing of the programmable controllers may occur due to, for example, a defect in a system, unexpected electric noise, or a temporary environmental influence from external noise due to a disaster as lightning or the like. A possible approach for preventing such a situation and stabilizing operational performance is to save and analyze log data on the processing performed by the programmable controllers.

### CITATION LIST

### Patent Literature

Patent Literature 1: Japanese Laid-open Patent Publication No. 2010-176545

### SUMMARY OF THE INVENTION

### Problem to be Solved by the Invention

Conventionally, however, the higher the operational performance of a programmable controller within a system, the higher the necessity for analyzing the log data. However, it is difficult to increase a processing load for saving the log data on the programmable controller which already bears a large processing load.

### Means for Solving Problem

A programmable controller included in a system comprising programmable controllers each having a storage and has an arithmetic processor and a transmitter. The arithmetic processor performs arithmetic processing for processing performed in the system. The transmitter controls transmission of log data to one of the programmable controllers of the system to store the log data in the storage of the one programmable controller having a lower arithmetic load on the arithmetic processor than that of the own programmable controller. The log data is associated with the arithmetic processing by the arithmetic processor.

### BRIEF DESCRIPTION OF DRAWINGS

FIG. 1 is a diagram illustrating an exemplary system configuration according to a first embodiment.

FIG. 2 is a block diagram illustrating a program configuration implemented by a program read from a non-volatile memory by a CPU of a programmable controller according to the first embodiment.

FIG. 3 is a flowchart of log data storing in the system according to the first embodiment.

FIG. 4 is a diagram illustrating an exemplary schematic system according to a second embodiment.

FIG. 5 is a diagram illustrating an exemplary system configuration according to the second embodiment.

FIG. 6 is a block diagram illustrating a program configuration implemented by a program read from a non-volatile memory by a CPU of a programmable controller according to the second embodiment.

### DETAILED DESCRIPTION

### First Embodiment

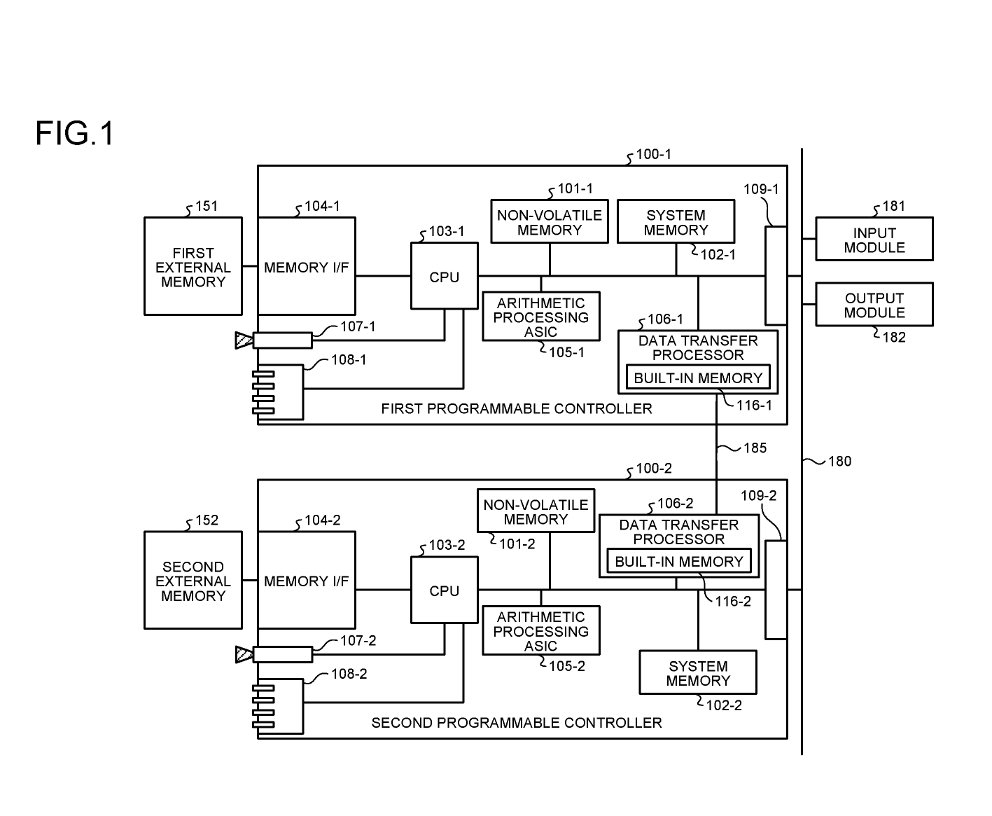

FIG. 1 is a diagram illustrating an exemplary system configuration according to a first embodiment. In the system, as illustrated in FIG. 1, a first programmable controller 100-1, a second programmable controller 100-2, an input module 181, and an output module 182 are connected to one another via a system bus 180.

The input module 181 is a module for delivering necessary input data for the processing by the programmable controllers 100-1, 100-2. The output module 182 is a module that performs processing according to output data from the programmable controllers 100-1, 100-2.

As illustrated in FIG. 1, the first programmable controller 100-1 includes a non-volatile memory 101-1, a system memory 102-1, a CPU 103-1, a memory I/F 104-1, an arithmetic processing ASIC 105-1, a data transfer processor 106-1, a stop switch 107-1, a switch group 108-1, and an internal bus I/F 109-1.

The system according to the present embodiment includes a duplex system configuration of the first programmable controller 100-1 and the second programmable controller 100-2. Each of the duplex programmable controllers according to the present embodiment mutually monitor their statuses and recognizes that they are active or on standby.

In the present embodiment, the first programmable controller 100-1 functions as an active system to perform processing in the system, and the second programmable controller 100-2 functions as a standby system to replace the first programmable controller 100-1 when the first programmable controller 100-1 is unable to handle the processing. The duplex system according to the present embodiment can thus implement a stable control.

In order to improve the operational stability of the system and examine the processing performed by the programmable controllers log data (including input data and output data) is preferably stored in the programmable controllers.

However, the active first programmable controller 100-1 has a large processing load for performing various types of processing for operating the system. Therefore, it may be difficult for the active first programmable controller 100-1 to perform the log data storing.

On the other hand, the standby second programmable controller 100-2 generally bears a small processing load since it does not perform processing during the operation of the first programmable controller 100-1.

In the present embodiment, therefore, while the first programmable controller 100-1 is in operation, the second programmable controller 100-2 stores, in a second external memory 152, log data on the processing performed by the first programmable controller 100-1.

The log data can be any data as long as the processing by the system can be verified by such data. Examples of the log data include input data required for arithmetic processing by the first programmable controller 100-1, the output data as a result of the arithmetic processing by the first programmable controller 100-1, intermediate data output while the first programmable controller 100-1 is calculating, and system parameters for the arithmetic processing. The present embodiment will describe an example in which the input data and the output data are stored as the log data.

In the present embodiment, the active programmable controller (e.g. first programmable controller 100-1) has an access right to the input module 181 and the output module 182 connected to the system bus 180. The standby programmable controller (e.g. programmable controller 100-2) does not have an access right to the system bus 180. Therefore, only the active programmable controller (e.g. first programmable controller 100-1) can access the input module 181 to obtain the input data, and access the output module 182 to set an arithmetic result, i.e. the output data for implementing output control.

The system memory 102-1 is a work area for the processing by the CPU 103-1 of the first programmable controller 100-1.

The CPU 103-1 controls the entire first programmable controller 100-1. For example, the CPU 103-1 controls the non-volatile memory 101-1, the system memory 102-1, the arithmetic processing ASIC 105-1, and the switch group 108-1 or the like connected via a bus. The CPU 103-1 also performs various types of control according to a program read from the non-volatile memory 101-1.

The memory I/F 104-1 functions as a connection interface connectable to a first external memory 151 or the like. The CPU 103-1 can detect the first external memory 151 or the like connected to the memory I/F 104-1.

The arithmetic processing ASIC 105-1 is an electronic circuit for performing the arithmetic processing for the processing performed in the system and for calculations necessary for the first programmable controller 100-1 to control a machine.

The data transfer processor 106-1 is an interface controller including a built-in memory 116-1 and connected to the data transfer processor 106-1 via a cable 185 for transmitting and receiving data to/from the second programmable controller 100-2. In the present embodiment, when the data is written to the internal memory 116-1, the second programmable controller 100-2 can refer to the data written to the internal memory 116-1 and control data transfer. The built-in memory 116-1 is a higher-speed readable and writable memory than the first external memory 151 and can be, for example, a static random access memory (SRAM). The second programmable controller 100-2 controls the data transfer processor 106-1 to transfer the data written to the built-in memory 116-1.

In the present embodiment, thereby, the log data can be transferred to the second programmable controller 100-2. Since a processing load for transferring the log data is smaller than that for writing the log data to the first external memory 151, the log data can be stored with no increase in the processing load.

The stop switch 107-1 is an emergency stop switch for urgently stopping, for example, the first programmable controller 100-1 or a device controlled by the first programmable controller 100-1. The switch group 108-1 is intended for controlling the programmable controller 100.

The internal bus I/F 109-1 is a connection interface with the system bus 180 that connects the elements inside the system.

The non-volatile memory 101-1 stores the program or the like to be executed by the first programmable controller 100-1. In the present embodiment, upon activation of the first programmable controller 100-1, the program stored in the non-volatile memory 101-1 is executed by the CPU 103-1 to implement various configurations.

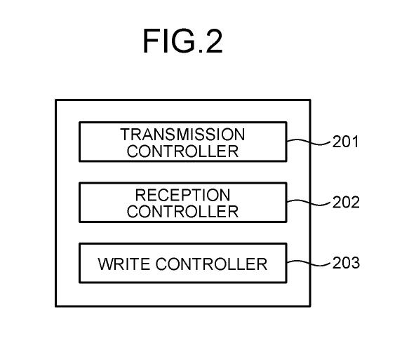

FIG. 2 is a block diagram illustrating a program configuration implemented by the program read from the non-volatile memory 101-1 by the CPU 103-1. As illustrated in FIG. 2, the CPU 103-1 executes the program to implement a transmission controller 201, a reception controller 202, and a write controller 203. The program according to the present embodiment includes a configuration to be executed by the active system and a configuration to be executed by the standby system, taking replacement of the active system with the standby system into account. For example, the program includes the transmission controller 201 as the configuration to be performed by the active system and the write controller 203 and the reception controller 202 as the configuration to be performed by the standby system.

The transmission controller 201 controls transmission of log data on the arithmetic processing by the arithmetic processing ASIC to another programmable controller (standby second programmable controller 100-2 in the present embodiment) having a lower arithmetic load on the arithmetic processing ASIC than that of the own programmable controller among the programmable controllers of the system, in order to store the log data in the external memory of another programmable controller.

The transmission controller 201 of the first programmable controller 100-1 implements the transmission control by writing the log data (e.g. input data and output data) to the built-in memory 116-1 of the data transfer processor 106-1. In the present embodiment, the transmission of the log data is controlled in such a manner that when the transmission controller 201 of the CPU 103-1 writes the log data to the built-in memory 116-1 of the data transfer processor 106-1 capable of writing data faster than the first external memory 151, a data transfer processor 106-2 of the second programmable controller 100-2 issues a command to the data transfer processor 106-1 of the first programmable controller 100-1.

Since processing units (not illustrated) of the data transfer processors 106-1, 106-2 handle such log data transmission control, the CPU 103-1 of the first programmable controller 100-1 does not have to perform any processing. After the log data transmission, the second programmable controller 100-2 controls the log data to be written to the second external memory 152. Thereby, the log data write control can be implemented with no processing load imposed on the first programmable controller 100-1.

The reception controller 202 controls reception of log data on the calculation by the arithmetic processing ASIC from another programmable controller having a higher arithmetic load on the arithmetic processing ASIC than that of the own programmable controller among the programmable controllers of the system. In the present embodiment, the reception controller 202 of the standby second programmable controller 100-2 controls the log data reception from the active first programmable controller 100-1.

For example, when the data transfer processor 106-2 of the second programmable controller 100-2 detects stored log data in the built-in memory 116-1 of the data transfer processor 106-1 of the first programmable controller 100-1, the reception controller 202 of the second programmable controller 100-2 commands the data transfer processor 106-2 to receive the log data. Thereby, the log data reception control is implemented.

In response to the command from the reception controller 202, the write controller 203 writes the log data received by the data transfer processor 106-2 to the external memory connected via a memory I/F 104-2 of the own programmable controller.

By implementing the above-mentioned configurations with the active system and the standby system, the log data on the arithmetic processing by the active system can be stored in the external memory of the standby system.

Returning to FIG. 1, the second programmable controller 100-2 includes a non-volatile memory 101-2, a system memory 102-2, a CPU 103-2, the memory I/F 104-2, an arithmetic processing ASIC 105-2, the data transfer processor 106-2 having a built-in memory 116-2, a stop switch 107-2, a switch group 108-2, and an internal bus I/F 109-2. Since the second programmable controller 100-2 includes the same configuration as that of the first programmable controller 100-1, descriptions thereof will be omitted.

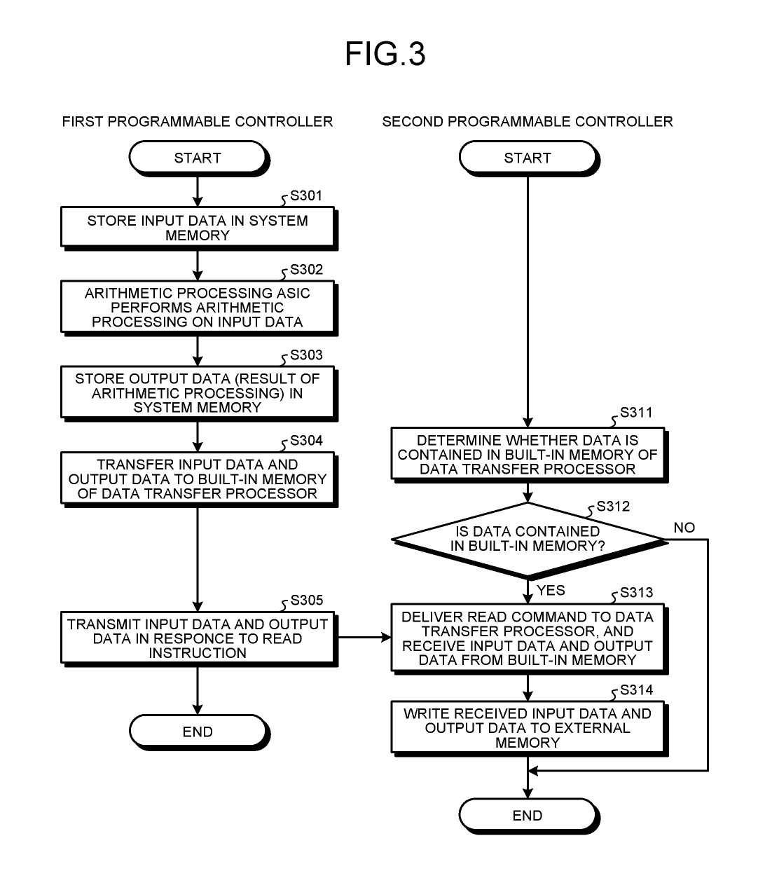

Next, log data storing in the system according to the present embodiment will be described. FIG. 3 is a flowchart of the above-mentioned processing in the system according to the present embodiment.

First, the CPU 103-1 of the first programmable controller 100-1 serving as the active system accesses the input module 181 to store the input data in the system memory 102-1 (step S301).

Next, the arithmetic processing ASIC 105-1 performs the arithmetic processing on the input data stored in the system memory 102-1 (step S302).

The arithmetic processing ASIC 105-1 then stores, in the system memory 102-1, a result of the arithmetic processing, i.e. the output data (step S303).

The transmission controller 201 of the CPU 103-1 then transfers the input data and the output data from the system memory 102-1 to the built-in memory 116-1 of the data transfer processor 106-1 (step S304). Thereby, the standby second programmable controller 100-2 can control the data transfer.

Meanwhile, the data transfer processor 106-2 of the second programmable controller 100-2 refers to, via the cable 185, the built-in memory 116-1 of the data transfer processor 106-1 of the first programmable controller 100-1 (step S311).

The reception controller 202 of the second programmable controller 100-2 then determines, based on a notice from the data transfer processor 106-2, whether the data is contained in the built-in memory 116-1 of the data transfer processor 106-1 of the first programmable controller 100-1 (step S312). When determining that the data is not contained (step S312: No), it ends the processing.

On the other hand, when determining that the data is contained in the built-in memory 116-1 (step S312: Yes), the reception controller 202 commands the data transfer processor 106-2 to receive the data. In response to the command, the data transfer processor 106-2 delivers a read command to the data transfer processor 106-1 of the first programmable controller 100-1.

In response to the read command, the data transfer processor 106-1 of the first programmable controller 100-1 transmits the input data and the output data from the built-in memory 116-1 to the second programmable controller 100-2 (step S305). The processing is then ended.

Meanwhile, the data transfer processor 106-2 of the second programmable controller 100-2 receives the log data (input data and output data) from the built-in memory 116-1 of the data transfer processor 106-1 (step S313).

The write controller 203 of the CPU 103-2 of the second programmable controller 100-2 controls the received log data (input data and output data) to be written to the second external memory 152 (step S314).

In the present embodiment, owing to the programmable controllers having the above-mentioned configurations, the log data can be recorded with no increase in the load on the active programmable controller.

### Second Embodiment

The first embodiment has described the example in which the log data is recorded by the standby programmable controller of the multiplex system. However, the programmable controller that records the log data should not be limited to the standby system of the multiplex system. In this regard, a second embodiment will describe an example of log data recording in a plurality of multiplex systems connected to each other by a network.

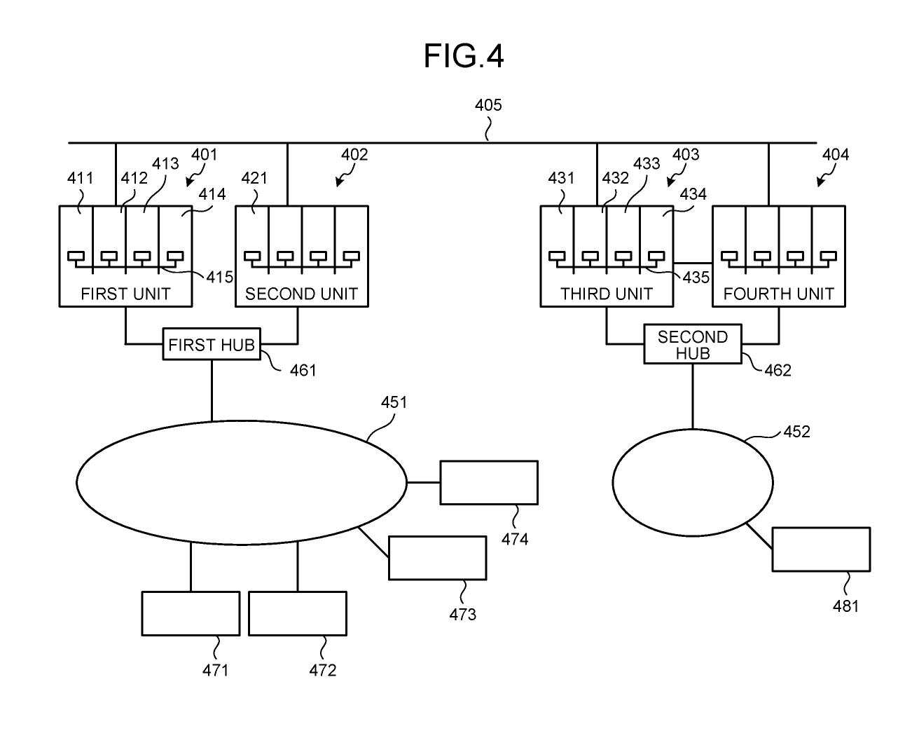

FIG. 4 is a diagram illustrating an exemplary schematic system according to the second embodiment. As illustrated in FIG. 4, a first system includes a first unit 401, a second unit 402, a first hub 461, a first network 451, and control devices 471 to 474.

In the first system, either of the first unit 401 and the second unit 402 controls the control devices 471 to 474. The first hub 461 controls switching between the active system and the standby system. Typically, the first unit 401 serves as the active system and the second unit 402 serves as the standby system.

In the present embodiment, the log data is transmitted and received among the active programmable controllers. For example, among the active programmable controllers, the active programmable controller bearing a higher processing load transmits the log data and the active programmable controller bearing a lower processing load controls reception of the log data and a writing of the log data to an external memory. Transmission and reception of the log data among the systems should not be limited to those among the active programmable controllers, and the standby programmable controller may also be used.

The first unit 401 includes a first programmable controller 411, a transmission module 412, an input module 413, and an output module 414. These elements are connected to one another via a built-in bus 415 in the first unit 401. Similarly, the second unit 402 includes a second programmable controller 421.

The driving first programmable controller 411 controls the control devices 471 to 474. The first programmable controller 411 controlling many devices has a higher load.

On the other hand, a second system includes a third unit 403, a fourth unit 404, a second hub 462, a second network 452, and a control device 481.

In the second system, either of the third unit 403 and the fourth unit 404 controls the control device 481. The second hub 462 controls switching between the active system and the standby system. Typically, the third unit 403 serves as the active system and the fourth unit 404 serves as the standby system.

The third unit 403 includes a third programmable controller 431, an input module 432, a transmission module 433, and an output module 434. These elements are connected to one another via a built-in bus 435 in the third unit 403.

The active third programmable controller 431 controls the control device 481. The third programmable controller 431 controlling the single device has a smaller processing load than the first programmable controller 411.

The groups of the units of the respective systems are connected to one another via a communication network 405.

In the present embodiment, log data on the arithmetic processing by the first programmable controller 411 is recorded by the third programmable controller 431.

FIG. 4 illustrates two systems each including the duplex programmable controllers by way of example. In practice, however, systems including a larger number of programmable controllers are connected to one another.

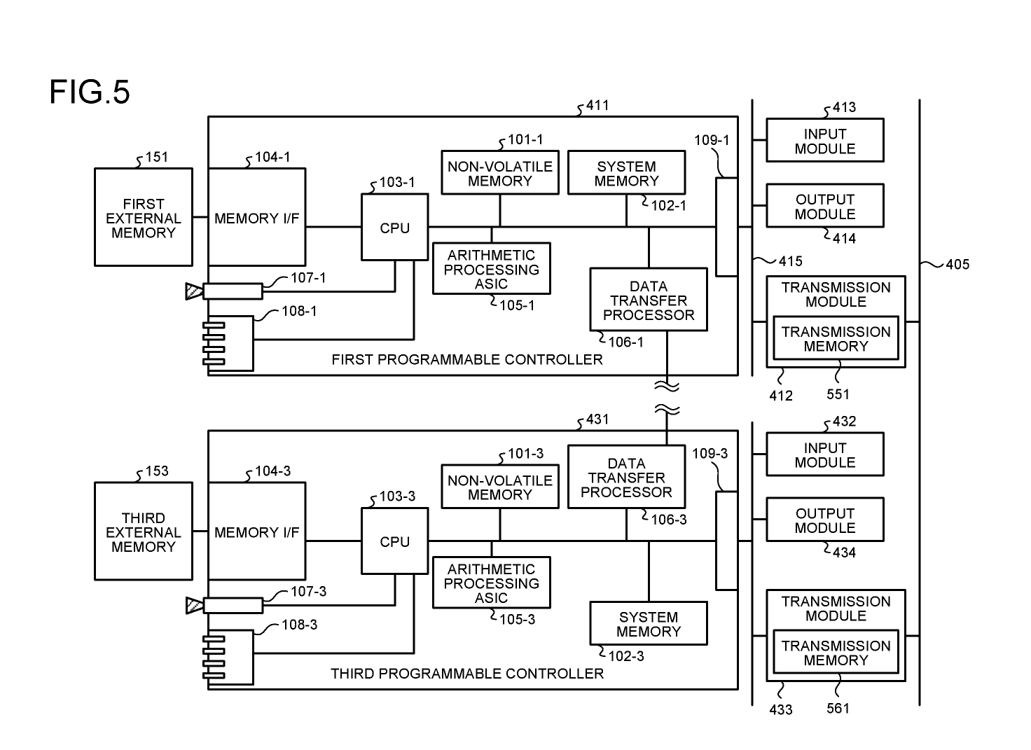

FIG. 5 is a diagram illustrating an exemplary system configuration according to the second embodiment. In the first unit 401, as illustrated in FIG. 5, the first programmable controller 411, the transmission module 412, the input module 413, and the output module 414 are connected to one another via the built-in bus 415.

The first programmable controller 411 includes elements identical to those in the first embodiment, i.e. a non-volatile memory 101-1, a system memory 102-1, a CPU 103-1, a memory I/F 104-1, an arithmetic processing ASIC 105-1, a data transfer processor 106-1, a stop switch 107-1, a switch group 108-1, and an internal bus I/F 109-1. The input module 413 and the output module 414 are also configured similarly to the input module 181 and the output module 182, respectively.

The transmission module 412 includes a transmission memory 551 for communicating with a device connected via the communication network 405.

Although given different reference signs, the third programmable controller 431 includes elements identical to those of the first programmable controller 100-1 according to the first embodiment, i.e. a non-volatile memory 101-3, a system memory 102-3, a CPU 103-3, a memory I/F 104-3, an arithmetic processing ASIC 105-3, a data transfer processor 106-3, a stop switch 107-3, a switch group 108-3, and an internal bus I/F 109-3. The input module 432 and the output module 434 are also configured similarly to the input module 181 and the output module 182 according to the first embodiment, respectively. Although a third external memory 153 is connectable to the memory I/F 104-3, a first external memory 151 or the like may also be connected to the memory I/F 104-3.

The transmission module 433 includes a transmission memory 561 for communicating with a device connected via the communication network 405.

The present embodiment differs from the first embodiment in the program executed by the first programmable controller 411 and the third programmable controller 431 and the program executed by the first programmable controller 100-1 and the second programmable controller 100-2 according to the first embodiment.

Next, the program executed by the first programmable controller 411 and the third programmable controller 431 will be described.

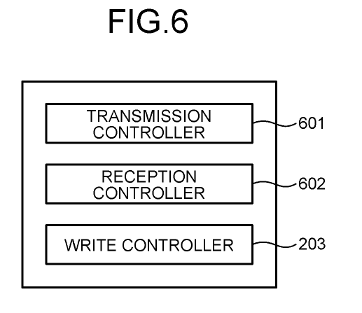

FIG. 6 is a block diagram illustrating a program configuration implemented by the program read by the CPU 103-1 from the non-volatile memory 101-1 or by the CPU 103-3 read from the non-volatile memory 101-3. As illustrated in FIG. 6, the CPUs 103-1, 103-3 execute the programs to implement a transmission controller 601, a reception controller 602, and a write controller 203. Since the processing of the write controller 203 is similar to that in the first embodiment, a description of the write controller 203 will be omitted.

The transmission controller 601 is a configuration used by the programmable controller having a high processing load (e.g. first programmable controller 411). The reception controller 602 and the write controller 203 are configurations used by the programmable controller having a low processing load (e.g. third programmable controller 431).

The transmission controller 601 controls, transmission of the log data via the communication network 405 to another programmable controller (e.g. third programmable controller 431) of another system, having a lower arithmetic load on the arithmetic processing ASIC than that of the own programmable controller. The transmission control may be performed at any timing, for example, in an interval between the calculations by the arithmetic processing ASIC 105-1.

For the transmission control of the log data to another programmable controller (e.g. third programmable controller 431) having a lower arithmetic load, the transmission controller 601 according to the present embodiment controls transmission of the log data from the internal bus I/F 109-1 to the transmission module 412 connected via the built-in bus 415, and then controls the transmission module 412 to store the log data in the transmission memory 551.

The transmission module 412 functions to broadcast the content of the transmission memory to the transmission modules (e.g. transmission module 332) linked to the communication network 405 between the controllers. Thereby, the log data is transferred from the transmission memory 551 to the transmission modules (e.g. transmission module 433) connected to the communication network 405.

When the transmission memory of one transmission module (e.g. transmission module 433) stores therein the data transmitted from another transmission module (e.g. transmission module 412), the reception controller 602 of the programmable controller (e.g. third programmable controller 431) controls reception of the log data from the transmission memory of the transmission module. The log data can be obtained via the communication network 405.

The write controller 203 processes the obtained log data as in the first embodiment to write the log data to the external memory.

The programmable controller may asynchronously determine whether transmission module data is included in the transmission module. In a case where a plurality of systems (e.g. three systems or more) is present in the communication network 405, the log data output from other systems can be stored in a single transmission memory.

The transmission controller 601 according to the present embodiment can control the transmission of the log data separately to the programmable controllers of the plurality of systems via the communication network 405. For example, the transmission controller 601 according to the present embodiment may instruct the transmission module (e.g. transmission module 412) to divide the log data and transmit the divided items of log data individually to the programmable controllers.

Thus, for dividing and storing the log data in the plurality of programmable controllers individually, the volume of the log data to be stored in the external memory may be shared by the programmable controllers according to their arithmetic loads. Although the log data is not stored in each programmable controller in chronological order, the log data can be processed, for example, combined, at the time of analysis.

In the present embodiment, the log data in an arbitrary programmable controller (e.g. first programmable controller) is controlled to be written to the external memories of the other programmable controllers (e.g. third programmable controller and fifth programmable controller (not illustrated)). In this case, the log data to be stored in the respective external memories may be hashed. Thereby, with occurrence of a log data extraction from any of the external memories by a third party, it is made possible to prevent the log data from being read and recovered. Furthermore, the log data may be encoded for transmission and reception over the communication network 405. These measures can bring security improvement.

The present embodiment has described the example in which the log data is divided and different log data are stored in the plurality of programmable controllers. Instead, control may be performed in such a way that the same log data is recorded in the external memories of the plurality of programmable controllers.

In the present embodiment as well, a processing load for the log data output to the transmission memory of the transmission module is smaller than that for the log data write to the external memory. This makes it possible for the programmable controller having a large processing load to record the log data without a substantial increase in the processing load.

Generally, as described in the above-mentioned embodiments, the system includes not a single programmable controller but a plurality of programmable controllers. The programmable controllers deal with a large volume of the input data and output data collect them by each scan, resulting in an enormous volume of the log data. It is difficult for the programmable controller having a large processing load to save such an enormous volume of the log data.

In the above-mentioned embodiments, for example, an NOR flash memory may be adopted for the external memory. Despite of a high data reliability, the NOR flash memory has a low writing speed to a device, causing a longer wait time for completion of the writing. Because of this, merely writing data to the external memory may not be sufficient for the programmable controller having a large processing load, resulting in a lack of resources for calculations of results.

In addition, when the data write overlaps data refresh or the like of the device, the low writing speed to the external storage medium may cause next data write to be unfeasible until previous data write is completed. In this case, with no log data written, the process may need to proceed to the next operation. This may result in a missing piece in the log data.

Meanwhile, the programmable controllers according to the above-mentioned embodiments includes the above-mentioned configurations, so that the programmable controller having a large processing load can reduce the processing load while the programmable controller having a small processing load controls the writing of the log data. This can abate a lack of the resources for the arithmetic processing and prevent occurrence of a missing piece in the log data. Reliability of the log data storing can thus be improved.

Some embodiments of the present invention have been described so far merely as examples. It is not intended to limit the scope of the invention to these embodiments. These novel embodiments can be implemented in various other forms, and can be variously omitted, replaced, and changed within the scope not deviating from the gist of the invention. These embodiments and variations thereof are included in the scope and gist of the invention as well as in the invention described in the scope of claims and equivalents thereof.

1. A programmable controller included in a system comprising a plurality of programmable controllers each having a storage, the programmable controller comprising:
an arithmetic processor that performs arithmetic processing for processing performed in the system; and
a transmitter that controls transmission of log data to one of the programmable controllers of the system to store the log data in the storage of the one of the programmable controllers, the one of the programmable controllers having a lower arithmetic load on the arithmetic processor than that of the own programmable controller, the log data associated with the arithmetic processing by the arithmetic processor.

2. The programmable controller according to claim 1, wherein
the programmable controller is included in the system comprising an active programmable controller and a standby programmable controller, the active programmable controller that performs the arithmetic processing, the standby programmable controller that performs the arithmetic processing when the active programmable controller does not handle the arithmetic processing, and
the transmitter controls the transmission of the log data to the standby programmable controller having a lower arithmetic load on the arithmetic processor than that of the own programmable controller.

3. The programmable controller according to claim 1, wherein
when systems each including an active programmable controller are present and connected to each other via a communication network, the transmitter controls the transmission of the log data to another programmable controller of another system via the communication network, the active programmable controller that performs the arithmetic processing, the another programmable controller having a lower arithmetic load on the arithmetic processor than that of the own programmable controller.

4. The programmable controller according to claim 3, wherein
the transmitter controls transmission of the log data divided to a plurality of other programmable controllers of the systems via the communication network.

5. A programmable controller included in a system comprising a plurality of programmable controllers each having a connection interface and an arithmetic processor, the connection interface connectable to an external storage, the programmable controller comprising:
a receiver that controls reception of log data from one of the programmable controllers of the system, the one of the programmable controllers having a higher arithmetic load on the arithmetic processor than that of the own programmable controller, the log data associated with a an arithmetic processing by the arithmetic processor of the one of the programmable controllers; and
a writer that writes the log data received by the receiver to the external storage of the own programmable controller.

6. The programmable controller according to claim 5, wherein
the programmable controller is included in the system comprising an active programmable controller and a standby programmable controller, the active programmable controller that performs arithmetic processing, the standby programmable controller that performs the arithmetic processing when the active programmable controller does not handle the arithmetic processing, and
the receiver controls the reception of the log data from the active programmable controller having a higher arithmetic load on the arithmetic processor than that of the own programmable controller.

7. The programmable controller according to claim 5, wherein
when systems each including an active programmable controller and a standby programmable controller are present and are connected to each other by a communication network, the receiver controls the reception of the log data from another programmable controller of another system via the communication network, the active programmable controller that performs arithmetic processing, the standby programmable controller that performs the arithmetic processing when the active programmable controller does not handle the arithmetic processing, another programmable controller having a higher arithmetic load on the arithmetic processor than that of the own programmable controller.

8. An arithmetic processing system comprising a plurality of programmable controllers each having a connection interface and an arithmetic processor, the connection interface connectable to an external storage, wherein
one of the programmable controllers, having a higher arithmetic load, includes:
an arithmetic processor that performs arithmetic processing for processing performed in the system; and
a transmitter that controls transmission of log data to another programmable controller to store the log data in the external storage of another programmable controller, another programmable controller having a lower arithmetic load on the arithmetic processor than that of the own programmable controller the log data associated with the arithmetic processing by the arithmetic processor, and
one of the programmable controllers, having a lower arithmetic load, includes:
a receiver that controls reception of log data from another programmable controller, another programmable controller having a higher arithmetic load on the arithmetic processor than that of the own programmable controller, the log data associated with an arithmetic processing by the arithmetic processor of another programmable controller; and
a writer that writes the log data received by the receiver to the external storage of the own programmable controller.
